(19) United States
(12) Patent Application Publication
(10) Pub. No.: US 2007/0235907 A1
(43) Pub. Date: Oct. 11, 2007

(54) Injection Molding Method and Injection Molding System with a Multi-Screw Extruder, in Particular a Ring Extruder

(76) Inventor: Andreas Christel, Zuzwil (CH)

Correspondence Address: Carella Byrne Bain Gilfillan Cecchi Stewart & Olst, Five Becker Farm Road, Roseland, NJ, 07068, US

(21) Appl. No.: 10/581,769

(22) PCT Filed: Oct. 28, 2004
(86) PCT No.: PCT/CH04/00644

§ 371 Date: Jun. 6, 2006

(30) Foreign Application Priority Data
Dec. 8, 2003 (DE) 103-57-578.2

(51) Int. Cl. B29C 45/46

(52) U.S. Cl. 264/537; 249/117; 264/299

(57) ABSTRACT

The invention relates to a method and installation for carefully producing injection molded parts made of thermoplastic materials at high rates. The invention also relates to a method and installation for carefully producing injection molded parts made of thermoplastic materials while involving the simultaneous homogeneous incorporation of additives or the compounding of plastic mixtures. Finally, the invention relates to an installation that enables the continuously running plasticizing step in a multiple-screw extruder (11; 31) to be economically combined with the intermittently running injection molding process.

The invention relates to a method and a system for gently manufacturing injection-molded parts out of thermoplastics at high throughputs. The invention further relates to a method and a system for gently manufacturing injection-molded parts out of thermoplastics while simultaneously incorporating additives or compounding plastic mixtures.

The invention relates further to a system that makes it possible to combine the continuous plasticization step in a multi-screw extruder with the intermittent injection molding process.

An injection molding process involving the use of single-screw extruders is known in prior art from multiple sources, e.g., from DE 1142229 and DE 4221423. Growing throughputs require increasingly large screw diameters, which results in very long extruders at a prescribed length-to-diameter ratio, and also no longer permits gentle melting above all for temperature-sensitive plastics, since the ever-diminishing surface-to-volume ratio must be offset by longer retention times and higher operating temperatures. Another disadvantage is that the compounding and degassing options are limited with a single-screw extruder, and that a given screw shank is optimally designed only for one input material.

The disadvantages described above are partially eliminated through the use of two-screw extruders, e.g., the dependence between throughput and speed enables an adjustment to several material specifications. Compounding options are also improved.

Such systems are disclosed in WO 86/06321, for example, in which a discontinuous extruder is used, or in WO 02/02293, in which a continuous two-screw extruder is used.

Despite this fact, the disadvantages described above persist in part, and it also remains necessary to use a plasticization extruder with further improved compounding and degassing options along with shorter retention times, and above all, a shorter overall length.

The object of the invention is to eliminate these disadvantages. In particular, the plasticization extruder is to be characterized by a high throughput capacity at a low overall length, good mixing and degassing characteristics, gentle treatment and short processing time.

This object is achieved via the method according to claim 1, as well as the system according to claim 9, wherein a continuously operating multi-screw extruder with screw shanks arranged on a rim line is used.

Additional embodiments are described in the specification below.

Possible thermoplastics include polycondensates, e.g., polyester, polyamide, polycarbonates and their copolymers and blends or polyolefins, e.g., polyethylene, polypropylene and their copolymers and blends. However, all thermoplastics can basically be used, as long as their rheological and thermal properties permit use in an injection molding process.

The polycondensates can include polyamides, polyester or polylactide obtained in a polycondensation reaction while separating out a low-molecular reaction product. Polycondensation can here take place directly between the monomers, or by way of an intermediate stage that is subsequently converted via transesterification, wherein transesterification can again take place while separating out a low-molecular reaction product or via ring opening polymerization.

The polyamide is here a polymer obtained via polycondensation from its monomers, either a diamine component or a dicarbonic acid component, or a bifunctional monomer with an amine and a carbonic acid end group.

The polyester here involves a polymer obtained via polycondensation from its monomers, a diol component and a dicarbonic acid component. Various, mostly linear or cyclic, diol components are used. Various, mostly aromatic dicarbonic acid components can also be used. The dicarbonic acid can be replaced by its corresponding dimethyl ester. Typical examples for polyester include polyethylene terephthalate (PET), polybutylene terephthalate (PBT) and polyethylene naphthalate (PEN), which are used either as a homopolymer or as copolymers.

The thermoplastics used can be either new or recycled.

Blends or plastic material mixtures can also be used as the thermoplastics.

The method according to the invention is also suitable for incorporating additives. The additives can be added prior to melting, either together with the polycondensate or via a separate metering and feeding device. The additives are here optimally mixed at the same time by the kneading elements during the melting process. The additives can also be added after melting in the extruder. The additives are added by means of a lateral feeding device, for example. Additional kneading or mixing elements can optionally be provided in the extruder to optimally mix the additives. In special cases, the additives can also be added only after the extruder.

Suitable additives include dyes and pigments, UV blockers, processing aids, stabilizers, impact modifiers, chemical and physical foaming agents, fillers like nucleating agents, particles that improve barrier or mechanical properties, reinforcing bodies, such as balls or fibers, along with reactive substances, for example oxygen absorbers, acetaldehyde absorbers or molecular weight-increasing substances, etc.

The additives can be added along or as part of an additive packet. Several additives are used to fabricate the additive packet. In addition, use can be made of a carrier material that allows incorporation of all additives. The additive packet can be present both as a homogenous powder or granulate, or as a simple additive mixture.

The thermoplastic is added to the process in a solid state, normally as a loose material like granulate, powder, agglomerate, flakes or chips. A granulate can here be cylindrical, globular or spherical, for example.

The thermoplastic can be dried prior to entry into the plasticization extruder. Drying can also take place at least in part outside the extruder.

A multi-screw extruder consists at least of a drive, a gearing and a processing section. The gearing is usually divided into a reduction gear and power divider, so that the individual screw shanks can be individually driven. The processing section is the part of the extruder in which the material to be processed is worked or conveyed by the screw shanks.

Filling takes place in an intake area of the processing section, e.g., via one or more intake funnels, through which one or more streams of material can be gravimetrically or volumetrically metered in. The addition of other components, e.g., additives or gases, for example for purposes of foaming, can also take place through openings in the melting area. Openings can also be used for degassing.

The processing section of the multi-screw extruder has numerous (at lest three, normally at least six, preferably at least eight) rotatable processing screws (screw shanks) that are arranged axially parallel to each other on a rim line in a casing, and exert a conveying action at least in partial areas, wherein the processing elements of adjacent screws intermesh tightly at least in part.

The casing has at least one material inlet, and at least one material outlet, as well as notches in the processing area interior walls on either side of the screw shanks that run parallel to each other and the screw shanks, in which the screw shanks are incorporated and guided, thereby defining a first partial processing area and a second partial processing area lying on one or the other side of the barrier formed by the screw shanks running parallel to each other.

In a special embodiment, the multi-screw extruder is a ring extruder in which at least six, in particular twelve, fully enclosed screw shanks are arranged in a rim or ring-like manner, wherein the interior of the screw rim incorporates a core. Such an extruder is described in DE 196 22 582, for example. Other embodiments can also be found in DE 102 11 673 and DE 10211673.

The invention enables high throughput levels:
Throughputs of up to 800 kg/h can be achieved with a processing section length of the plasticization extruder of less than 1000 mm, in particular less than 650 mm.
Throughputs of up to 1500 kg/h can be achieved with a processing section length of the plasticization extruder of less than 1250 mm, in particular less than 820 mm.
Throughputs of up to 2500 kg/h can be achieved with a processing section length of the plasticization extruder of less than 1500 mm, in particular less than 1000 mm.

In a generally valid correlation, throughput number Z can be expressed as a function of the processing section length L and throughput Q as follows:
Z=Q/L^{ˆ2.8}, wherein Q is in [kg/h] and L in [m].

According to the invention, Z is greater than 800, in particular greater than 2750.

The process retention time must be kept as short as possible to gently handle the plastic. While the retention time in the buffer containers is determined by the cycle time, the retention time in the plasticization extruder and melt flow-ways can be optimized. The average retention time of the plasticized plastic in the process from the moment melting begins until the point of injection into the injection molding tool must not exceed 60 seconds plus the cycle time, in particular no more than 30 seconds plus the cycle time. The average retention time of the plasticized plastic in the processing section of the plasticization extruder from the moment melting begins until the point of exit from the processing section must not exceed 15 seconds, in particular 10 seconds.

The processing section can be followed by components for building up pressure, e.g., a melt pump, a melt filter, devices for measuring Theological properties, on-off valves and/or buffer containers.

The plasticized plastic is pressed into an injection molding tool via a melt flow-way. Injection molding tools are sufficiently known from prior art. The injected plastic melt is distributed to one or more cavities via distribution channels, and solidifies in the desired shape.

The plasticized plastic is most preferably first injected into at least one buffer container, and from there into the injection molding tool. The plasticized plastic can be prevented from flowing back into the extruder by means of an on-off valve.

The buffer container is designed in such a way that its volume increases for accommodating the plasticized plastic, and decreases again for ejecting the plasticized plastic, which can be achieved by a movable piston, for example. Ejection normally takes place more quickly than filling the buffer.

In order to ensure the continuous operation of the plasticization extruder while intermittently pressing the plasticized plastic into the injection molding tool, the screw shanks are mounted in an axially shiftable manner in a special embodiment, giving rise to a buffer area in the processing section during an axial shift toward the back. This is achieved either by:
a) screw shanks that can be axially shifted relative to the power divider,
b) screw shanks that can be axially shifted together with the power divider relative to the reduction gear,
c) screw shanks that can be axially shifted together with the power divider and the reduction gear relative to the drive,
d) screw shanks that can be axially shifted together with the power divider, reduction gear and drive,
e) a processing section casing that can be axially shifted relative to the screw shanks,
f) the core inside the screw shank rim of a ring extruder can be axially shifted relative to the screw shanks.

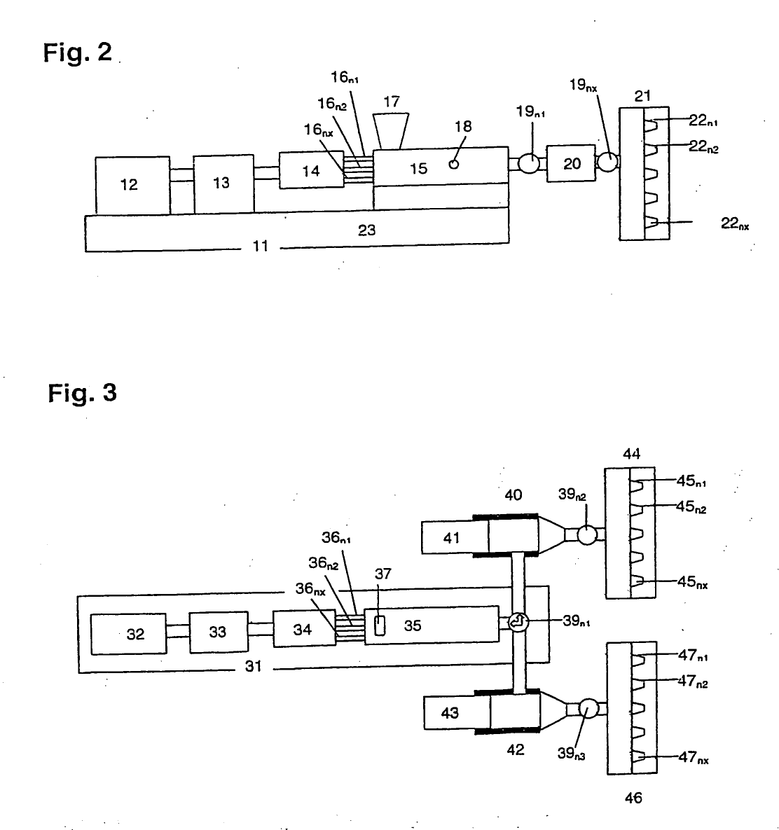

FIG. 2 shows variant b), in which the axial shift is absorbed in the reduction gear, which is rigidly secured to the frame.

Continuous operation can also be ensured by a second buffer container arranged between the plasticization extruder and the first buffer container.

Another possibility would be to use a downstream tandem extruder with an axially shiftable screw shank.

It is also conceivable to make the center screw described in DE 10211673 axially shiftable.

In another embodiment of the invention, the system has at least one on-off valve and at least two buffer containers, wherein the plasticized plastic is variably pressed into the buffer container via the on-off valve and either
a) pressed into an allocated injection molding tool from a respective buffer container, or
b) pressed into a single injection molding tool from the at least two buffer containers via another on-off valve.

FIG. 3 shows variant a), in which two separate injection molding tools are used.

If an injection molded part is to be fabricated out of several layers of material, several plasticization extruders can be used, wherein at least the one with the higher throughput must satisfy the requirement according to the invention. The several layers of material can here be generated simultaneously or consecutively.

One embodiment of the method provides for the manufacture of parisons for hollow items, in particular beverage bottles. In this case, for example, a polyethylene terephthalate or one of its copolymers is first preliminarily dried and then melted in a ring extruder, after which it is pressed into a plurality of cavities of at least one injection molding tool. Drying can also take place inside the extruder via degassing both before and after melting, making it possible to achieve tangible energy savings compared to conventional methods of today.

The method according to the invention can be executed by means of a co-rotating multi-screw extruder, whose processing area has a jacket surface Am and a free volume Vf, wherein the screw elements have an outer diameter Da at the screw thread, and an inner diameter Di at the screw base, and wherein at least part of the process zone has an Am³/Vf² ratio≧1020 for two-start screw elements, and an Am³/Vf²≧2000 for three-start screw elements given a Da/Di ratio=1.3 to 1.7.

The method according to the invention can also be performed using a co-rotating multi-screw extruder, whose processing area has an intermeshing zone Az and a free volume Vf, wherein the screw elements have an outer diameter Da at the screw thread, and an inner diameter Da at the screw base, and wherein at least part of the process zone has an Az³/Vf² ratio≧5×10⁻¹ for two-start screw elements, and an Az³/Vf² ratio≧2×10⁻² for three-start screw elements given a Da/Di ratio=1.3 to 1.7.

In this case, a torque density (torque per screw/axial distance³) of at least 7 Nm/cm³, in particular of at least 9 Nm/cm³, is preferably introduced in the extruder.

It is particularly advantageous if the Da/Di ratio=1.5 to 1.63, and if the Az³/Vf² ratio≧1500 for two-start screw elements and the Az³/Vf² ratio≧3000 for three start screw elements.

Additional advantages, features and possible applications of the invention can be gleaned from the following description of embodiments according to the invention based on the drawing, wherein:

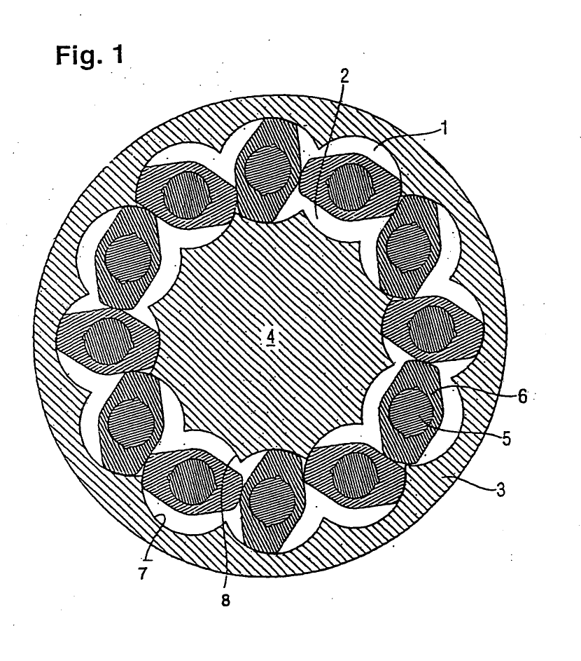

FIG. 1 is a side view of a ring extruder from prior art along a plane perpendicular to the conveying or longitudinal direction of the extruder;

FIG. 2 is a side view of a first embodiment of the system according to the invention;

FIG. 3 is a top view of a second embodiment of the system according to the invention.

FIG. 1 is a side view of a ring extruder from prior art along a plane perpendicular to he conveying or longitudinal direction of the extruder. In this case, the ring extruder consists of twelve fully-enclosed screw shanks that are arranged in a rim-like manner and run parallel to the longitudinal or conveying direction of the extruder, and are comprised of carrier screws 5 and processing elements 6, which exert a conveying effect at least in partial areas. The twelve fully-enclosed screw shanks 5, 6 arranged in a rim-like manner are situated in such a way that the processing elements 6 of adjacent screws intermesh tightly at least in part, and that the outer processing area 1 of the ring extruder is separated from the inner processing area 2 of the ring extruder at least in partial areas. The screws 5 arranged in a rim-like manner are mounted between a casing 3 and a core 4 fixed relative to the casing. The surface of the casing 3 facing the screw rim looks like a so-called external flower 7 in cross section. The surface of the core 4 facing the screw rim resembles a so-called internal flower 8 in cross section.

FIG. 2 shows a side view of a multi-screw extruder 11 with a drive 12, a reduction gear 13, a power divider 14 and a processing section 15. The individual screw shanks 16ₙ₁ to 16ₙₓ are individually driven via the gear. Filling takes place by way of an intake funnel 17. Additional components can be added through openings in the melting area 18.

The processing section is followed by two on-off valves 19ₙ₁ to 19ₙ₂ and a buffer container 20, wherein the stream of plastic is controlled via the on-off valves as the buffer container is filled and evacuated. A melt line is used to press the plasticized plastic into an injection-molding tool 21, and distribute it to several cavities 22ₙ₁ to 22ₙₓ through distribution channels. Injection-molding tools are sufficiently known in prior art. The injected plastic melt is cooled, and solidifies in the desired shape.

With the on-off valve 19ₙ₁ closed, a buffer area must be generated inside the extruder by moving the screw shanks toward the back. To this end, the power divider is rigidly connected with the screw shanks, and moves relative to the reduction gear, which is rigidly secured to the frame 23.

FIG. 3 shows a top view of a multi-screw extruder 31 with a drive 32, a reduction gear 33, a power divider 34 and a processing section 35. The gearing separately drives the individual screw shanks 36ₙ₁ to 36ₙₓ. Filling takes place via an intake funnel 37.

The processing section is followed by an on-off valve 39ₙ₁, which can alternately route the plasticized plastic to one of the two buffer containers 4, 42. Shown as a constituent of each buffer container is a respective piston 41, 43, which can be used to increase and decrease the buffer container volume. The on-off valves 39ₙ₂, 39ₙ₃ can be used to regulate the flow of plastic while filling and evacuating the buffer container 40, 42. The plasticized plastic is pressed into the respective accompanying injection-molding tool 44, 46 via a melt line, and distributed to several cavities 45ₙ₁ to 45ₙₓ or 47ₙ₁ to 47ₙₓ via distribution channels.

### REFERENCE MARKS

1 Outer processing area 22ₙ₁-22ₙₓ Cavities
2 Inner processing area 23 Frame
3 Casing 31 Multi-screw extruder
4 Core 32 Drive
5 Supporting screws 33 Reduction gear
6 Processing elements 34 Power divider
7 External flower 35 Processing section
8 Internal flower 36ₙ₁-36ₙₓ Screw shanks
11 Multi-screw extruder 37 Intake funnel
12 Drive 39ₙ₁-39ₙ₃ On-off valves
13 Reduction drive 40 Buffer container
14 Power divider 41 Piston
15 Processing section 42 Buffer container
16ₙ₁-16ₙₓ Screw shanks 43 Piston
17 Intake funnel 44 Injection molding tool
18 Melting area 45ₙ₁-45ₙₓ Cavities
19ₙ₁-19ₙ₂ On-off valves 46 Injection molding tool
20 Buffer container 47ₙ₁-47ₙₓ Cavities
21 Injection molding tool

1. A method for manufacturing injection molded articles out of thermoplastic plastics, comprised of:
g) a step for plasticizing the plastic;
h) a step for pressing the plasticized plastic into at least one mold,
characterized in that the plastic is platicized in a continuously running multi-screw extruder with at least three screw shanks that intermesh tightly at least in partial areas and are arranged on a rim line, in particular a ring extruder with at least six screw shanks that intermesh tightly at least in partial areas and are arranged in a rim-like manner.

2. The method according to claim 1, characterized in that the thermoplastic is a polycondensate, in particular a polyester.

3. The method according to one of the preceding claims, characterized in that the polycondensate is dried prior to plasticization.

4. The method according to one of the preceding claims, characterized in that the quantity of plasticized plastic exceeds 800 kg/h, in particular exceeds 1000 kg/h.

5. The method according to one of the preceding claims, characterized in that the plasticized plastic is subjected to one or more of the following steps, which involve
a) degassing,
b) mixing with additives,
c) filtration,
d) increasing the pressure using a melt pump,
e) determining the Theological properties,
f) buffering in at least one buffer container, so that plasticization can take place continuously, and pressing in a mold can take place discontinuously.

6. The method according to one of the preceding claims, characterized in that the plasticized plastic is alternately relayed by an on-off valve relay to one of at least two buffer containers, and either
a) pressed into an injection molding tool allocated to the respective buffer container, or
b) pressed into a single injection-molding tool via another on-off valve.

7. The method according to one of the preceding claims, characterized in that the average retention time of the plasticized plastic in the process must not exceed 60 seconds plus the cycle time, in particular must not exceed 30 seconds plus the cycle time, and/or the average retention time of the plasticized plastic in the processing section of the plasticization extruder must not exceed 15 seconds, in particular must not exceed 10 seconds.

8. The method according to one of the preceding claims, characterized in that a plurality of hollow items, in particular parisons for food packaging, such as beverage bottles, is manufactured out of a thermoplastic, e.g., polyester, by pressing the plasticized plastic into a plurality of cavities of an injection molding tool.

9. A system for manufacturing injection molded articles out of thermoplastic plastics, which has at least one plasticization extruder (11; 31) and at least one injection molding tool (21; 44, 46), characterized in that the plasticization extruder involves a continuously operating multi-screw extruder with at least three screw shanks (16ₙ₁-16ₙₓ; 36ₙ₁-36ₙₓ) that tightly intermesh at least in partial areas and are arranged on a rim line.

10. The system according to claim 9, characterized in that the plasticization extruder (11; 31) has a throughput z exceeding 800, in particular exceeding 2750, wherein
Z=Q/L^{ˆ2.8}, wherein Q is calculated in [kg/h] and L in [m].

11. The system according to one of claims 9 to 10, characterized in that the multi-screw extruder (11; 31) involves a ring extruder with fully enclosed screw shanks arranged in a rim-like manner.

12. The system according to one of claims 9 to 11, characterized in that the plasticization extruder (11; 31) has at least one drive (12), a reduction gear (13), a power divider (14) and a processing section (15), wherein the processing section exhibits one or more of the following components:
a) one or more material inlets,
b) one or more metering devices connected with a material inlet,
c) one or more outlets,
d) one or more vacuum stations connected with an outlet,
and that a melting path is allocated to at least one injection molding tool (21; 44, 46), wherein the melting path can have one or more of the following components:
e) a melt pump,
f) one or more measuring devices for ascertaining rheological data,
g) one or more melt filters,
h) one or more buffer containers,
i) one or more on-off valves.

13. The system according to one of claims 9 to 12, characterized in that the melting path has at least one on-off valve (39ₙ₁) and at least two buffer containers (40, 42), wherein the on-off valve establishes a respective connection between the plasticization extruder (31) and a buffer container (40, 42), and
a) a respective buffer container is either connected with an allocated injection molding tool (44, 46), or
b) the at least two buffer containers are connected with a single injection molding tool by way of an additional on-off valve.

14. The system according to one of claims 9 to 13, characterized in that the screw shanks (16ₙ₁-16ₙₓ; 36ₙ₁-36ₙₓ) can be axially shifted, giving rise to a buffer area in the processing section during an axial shift toward the back, wherein
a) the screw shanks can be axially shifted relative to the power divider (14),
b) the screw shanks can be axially shifted together with the power divider (14) relative to the reduction gear (13),
c) the screw shanks can be axially shifted together with the power divider (14) and the reduction gear (13) relative to the drive (12),
d) the screw shanks can be axially shifted together with the power divider (14), reduction gear (13) and drive (12)
e) the processing section casing can be axially shifted relative to the screw shanks, or
f) the core inside the screw shank rim of a ring extruder can be axially shifted relative to the screw shanks.

15. The system according to one of claims 9 to 14, characterized in that the injection molding tool (21; 44, 46) exhibits several cavities (22ₙ₁-22ₙₓ; 45ₙ₁-45ₙₓ, 47ₙ₁-47ₙₓ) for manufacturing parisons for food packaging, in particular beverage bottles,
